(19) United States
(12) Patent Application Publication
(10) Pub. No.: US 2020/0328990 A1
(43) Pub. Date: Oct. 15, 2020

(54) Intelligent Scheduler for Chatbot Sessions

(71) Applicant: International Business Machines Corporation, Armonk, NY (US)

(72) Inventor: Nadiya Kochura, Bolton, MA (US)

(21) Appl. No.: 16/379,886

(22) Filed: Apr. 10, 2019

(51) Int. Cl. H04L 12/58; H04L 29/06; H04L 29/08

(52) U.S. Cl. CPC H04L 51/02; H04L 67/325; H04L 51/20; H04L 65/1066

(57) ABSTRACT

An approach is provided that analyzes a chat session between a user and a chatbot application. The analysis results in a set of one or more criteria pertaining to a second chat session between the user and the chat application. The approach then monitors a set of conditions and compares the set of conditions to the criteria. When a match is found, the approach automatically initiates the second chat session between the user and the chatbot application.

### BACKGROUND

A chatbot (also known as a smartbot, talkbot, chatterbot, Bot, IM bot, interactive agent, conversational interface, Conversational AI, or artificial conversational entity) is a computer program or an artificial intelligence which conducts a conversation with a user using auditory or textual methods. Chatbots are often designed to convincingly simulate how a human would behave as a conversational partner and are often used in dialog systems for various practical purposes including customer service or information acquisition. People are more frequently relying on chatbots in their everyday activities. Personalized conversational chatbots (also called personal assistants) can perform various tasks assigned to them during conversation. For example chatbots can perform various search tasks such as finding the nearest pet friendly hotel, providing recommendations on weight based activities for gym. The interactive dialog between a user and the chatbot is referred to as a chat session. The chat session can be interrupted or ended by the user with the intent to continue or resume chat at later time. Therefore, the results of a chatbot session are often retained and then later restored and delivered during the next chat session with the user.

### SUMMARY

An approach is provided that analyzes a chat session between a user and a chatbot application. The analysis results in a set of one or more criteria pertaining to a second chat session between the user and the chat application. The approach then monitors a set of conditions and compares the set of conditions to the criteria. When a match is found, the approach automatically initiates the second chat session between the user and the chatbot application.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a knowledge manager that utilizes a knowledge base;

FIG. 2 is a block diagram of a processor and components of an information handling system such as those shown in FIG. 1;

FIG. 3 is a component diagram that shows the interaction between components utilized in the intelligent scheduler for chatbot sessions system;

FIG. 4 is a depiction of a flowchart showing the logic used to implement the intelligent scheduler for chatbot sessions system;

FIG. 5 is a depiction of a flowchart showing the logic used to implement the chat analyzer and trigger generation component; and

FIG. 6 is a depiction of a flowchart showing the logic performed during the event monitoring and automatic chat session generation.

### DETAILED DESCRIPTION

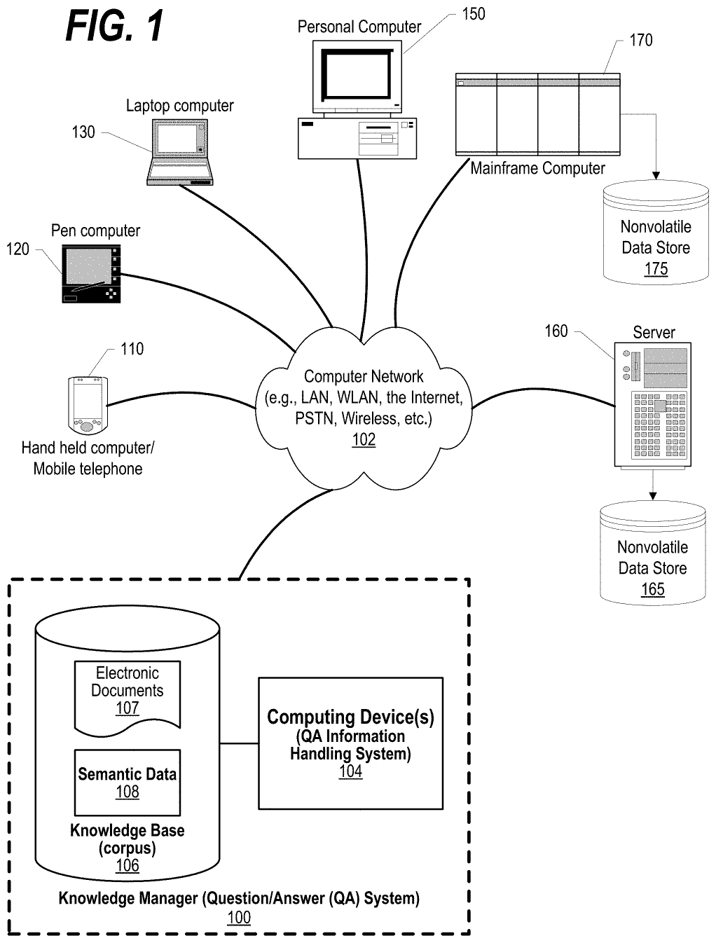

FIGS. 1-6 describe an approach that addresses scheduling follow-up or conditional chatbot sessions. To be able to schedule future chat sessions, the system that implements the approach considers the following factors: (1) when to trigger the chatbot session, (2) what content to deliver or what chat subject during the chatbot session, (3) how to deliver the content or format during the next chatbot session, and (4) where the endpoint or type of application is located and/or what device is to be used during the chatbot session. In other words, the approach addresses the WHEN, WHERE, HOW and WHAT of the chatbot sessions.

The approach described herein is a system that builds and schedules the chatbot sessions. The system creates and relies upon intelligent analyses of the current chat sessions. The system further identifies the content, format, and communication type and creates chat triggering events. The system that then monitors the event conditions and detects matching conditions to trigger scheduled chats. The system analyzes the current chat session and generates chat triggering event with chat session attributes. These session attributes include: WHAT—defines the session content or the session subject. For example delivering search agent results on booking the flight, or providing summary on specific paper. WHERE—specifies targeted device and application. For example, email, messages, snapchats, Slack, etc. WHEN—schedules chat session upon verifying chat triggering conditions are met. Example of conditions include daytime, location, activities, user's cognitive state, weather, IOT sensors, etc. Finally, HOW—defines the format for conversation session. For example using text, voice, video format, etc.

The system performs various steps to implement the approach described herein. First, the system analyzes a current chat sessions between a user and the chatbot and collects data for generating chat triggering event. During the analysis, the system identifies the condition for scheduling the next chat session. The system is trained to recognize various types of conditions from the conversation that are explicitly mentioned or deducted from the context. The following are some examples of conditions that might be recognized by the system:
{condition=“datetime”, phrases: [“talk to you tonight”, “see you tomorrow”, “ping me after thanksgiving”}
{condition=“weather”, value=“snow report”, phrases: [“remind me that when it starts to snow”}
{condition=“IOT sensors”, value=“light sensors”, phrases: [“lets talk when electricity is back in the house”}
{condition=“location”, value=“gym”, phrases: [“ping me when I'm in a gym”]
{condition=“cognitive”, value=“stressed”, phrases:[“talk to you when feel better”, “tired, cannot think now” ]

During analysis, the system also identifies the content or subject for the follow up chat. The system is trained to detect from the utterances the descriptions of the task. System then formulates an executable task for the chatbot. For example:
User: “I need to drive today to the city ABC. Can you search the nearest pet friendly hotel.”
Chatbot: “Sure.”

In this example, the system creates the search task for the chatbot with the search attributes “pets friendly hotel nearby ABC.”

The system also identifies the effective format and type of communication by considering and ranking various factors. The system is trained to detect the effective format of communication from utterances. For example:
{type=“email”, phrases: [“email the results”, “look at email later”, “email once done”, “better email me”}
{type=“messaging”, phrases: [“ping me later”, “message me with summary”, “sms is better”}

In addition, the system suggests the format based on the user location or activities. For example, the system might associate the “driving” activity with the delivery format=“voice”.

The system creates chat triggering event and places it in the monitored session event queue. The system creates a chat triggering event with the following attributes:
conditions: {datetime, user's cognitive state, activity, weather, IOT sensors}
content: {link to the search result, article summarization}
type of communications:{email, messaging, chatbot app}
format: {text, voice, video}

The system creates multiple various events based on the analyzed sessions. The system then scans the scheduled events queue and verifies if certain event conditions are met. This verification uses various data sources gathered by the system to verify if the current conditions matches conditions defined in the chat trigger event.
Weather conditions—system uses weather services
Date/Time condition—system verifies date/time of the system matches date/time of the event.
Location conditions—system uses GPS data to compare the current location with.
User's cognitive and health state—system uses various sensor data to evaluate the mood or the health state of the user.
Activity and driving condition—system uses sensor data and GPS data.
IOT and Sensor condition—system uses IOT sensor data.

When the system detects that the matching event is an event with conditions matching current conditions, the system creates a chat instance. To create a chat instance, the system uses available chat templates for various conditions and formats and populates the templates with data from the matching event. For example, the system might replace a hyperlink parameter with a real hyperlink that is directed to particular search results. Finally, the system invokes the chat instance creating a chat session between the chatbot and the user.

The following is an example usage of the system with the user starting the original conversation flow as follows:
User: “Hi bot !”
Bot: “Hello my friend!”
User: “Can you search for workouts with weights suited to my age and fitness level?”
Bot: “Yes”
User: “Great ! Please ping me when I'm in the gym? See you !”

In this example, the system collects search results “gym activities with weights” for that user's fitness level and age. The system identifies the format for communication as messaging and creates the conversation trigger event such as:
Event_1={condition:{location=gym},application=messaging, content=<link to the workout>,format=text}

The system then verifies that the event condition matches the current location of the user. When this occurs, the system sends message to the user such as follows:
Bot: “hey, got your workout plan. Open your video stream viewer or the browser to view the instructions”
User: “great”
Bot: “talk to you after workout.”

The following is another example usage of the system with the system detecting that the user is driving and the system verifying that there is a scheduled chat event that maps to the activity=“driving” with the queued event appearing such as:
Event_2={condition:{activity=driving}, device=mobile, application=chatBotApp, content=<link to the hotels>, format=voice}

Given the matching event condition, the system triggers a voice based chat such as the following:
Bot: “I see you driving, is it a good time to talk?”
User: “yes.”
Bot: “I found a pet friendly hotel nearby.”
User: “Please give me the name and directions.”

At this point in the example, the bot commences reading the name of the hotel and the directions to the hotel and also activates a GPS voice-based route builder to guide the user to the hotel of interest.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 1 depicts a schematic diagram of one illustrative embodiment of a question/answer creation (QA) system 100 in a computer network 102. QA system 100 may include a knowledge manager computing device 104 (comprising one or more processors and one or more memories, and potentially any other computing device elements generally known in the art including buses, storage devices, communication interfaces, and the like) that connects QA system 100 to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. QA system 100 and network 102 may enable question/answer (QA) generation functionality for one or more content users. Other embodiments of QA system 100 may be used with components, systems, sub-systems, and/or devices other than those that are depicted herein.

QA system 100 may be configured to receive inputs from various sources.

For example, QA system 100 may receive input from the network 102, a corpus of electronic documents 107 or other data, a content creator, content users, and other possible sources of input. In one embodiment, some or all of the inputs to QA system 100 may be routed through the network 102. The various computing devices on the network 102 may include access points for content creators and content users. Some of the computing devices may include devices for a database storing the corpus of data. The network 102 may include local network connections and remote connections in various embodiments, such that knowledge manager 100 may operate in environments of any size, including local and global, e.g., the Internet. Additionally, knowledge manager 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator creates content in electronic documents 107 for use as part of a corpus of data with QA system 100. Electronic documents 107 may include any file, text, article, or source of data for use in QA system 100. Content users may access QA system 100 via a network connection or an Internet connection to the network 102, and may input questions to QA system 100 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language (NL) Processing. Semantic data 108 is stored as part of the knowledge base 106. In one embodiment, the process sends well-formed questions (e.g., natural language questions, etc.) to the knowledge manager. QA system 100 may interpret the question and provide a response to the content user containing one or more answers to the question. In some embodiments, QA system 100 may provide a response to users in a ranked list of answers.

In some illustrative embodiments, QA system 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question.

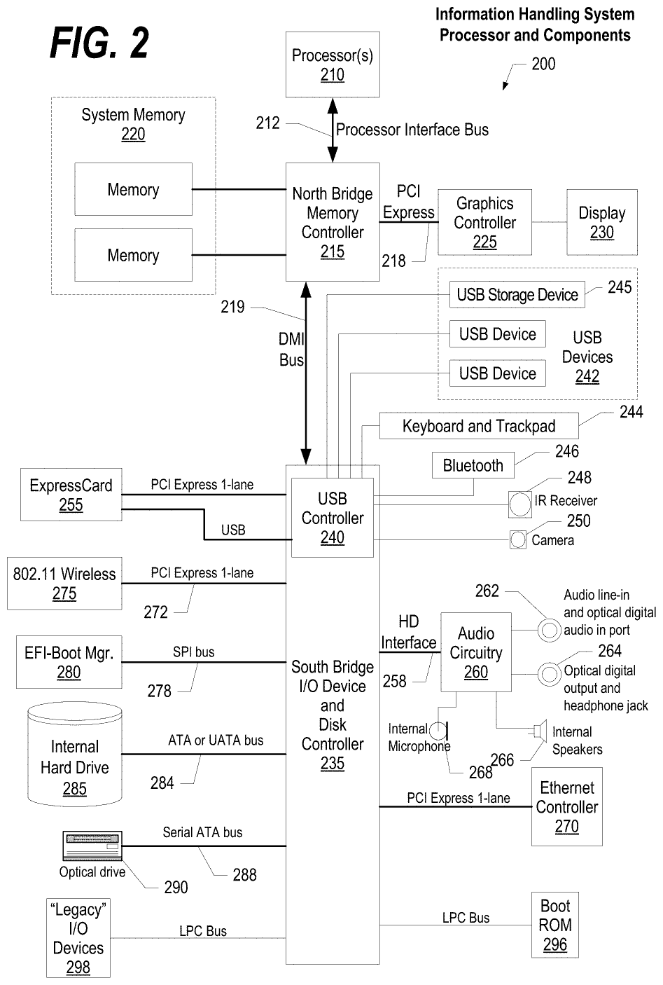

Types of information handling systems that can utilize QA system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 102. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE 0.802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

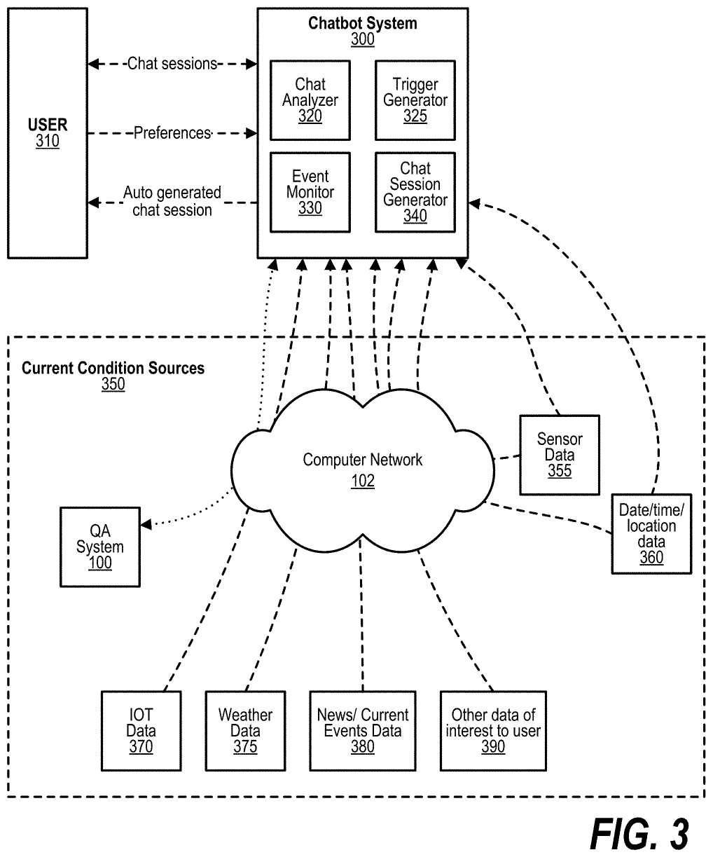

FIG. 3 is a component diagram that shows the interaction between components utilized in the intelligent scheduler for chatbot sessions system. Chatbot system 300 includes a number of functions that work together to provide the chatbot functionality described herein. These functions include chat analyzer function 320 that analyzes input from user 310 and to determine the desires or wishes of the user. One type of desire that might be discovered during a chat session with the user is the user's desire for a future chat session when some criteria is met. For example, the user might ask the chatbot to download and provide a workout to the user when the user arrives at a gym. When the chatbot system detects that the user has arrived at the gym, the system provides the workout to the user. Multiple criteria can be utilized to form more complex conditions, such as the user requesting to be provided with nearby emergency shelter information when the user is driving his or her automobile and severe weather is predicted in the user's current area. Here, the system detects both that the user is driving and that severe weather is imminent before providing the user with such emergency information.

In addition, the delivery mechanism that the chatbot system uses might be different based upon current condition data. Using the above examples, the chatbot system might provide textual or video instructions to the user for the workout, with a video perhaps providing examples of how various exercises are performed. However, in the driving example, the system might use audible communication so that the user can listen to the emergency shelter information provided by the system without having to read the information on a display screen, potentially distracting the driver in what might be difficult travel conditions. Likewise, the system can interface with other systems, such as an automobile's GPS system, with the system directing the GPS system, either using the automobiles voice-input capabilities or other interface, to provide on-screen GPS directions to the nearest emergency shelter.

Other functions provided by the chatbot system include trigger generation function 325 that uses criteria identified in by the chat analyzer function to create triggers that are compared to current conditions to trigger a particular type chatbot session that has been requested by the user. The trigger generator function works in conjunction with event monitor function 330 that monitors current condition sources 350 for comparison with criteria corresponding with various established triggers. Finally, when criteria matches current condition sources, chat session generator function 340 is used to automatically generate a second (follow-on) chat session between the chat system and the user. Content is provided to the user by the chat system during the automatically generated session. In one embodiment, chatbot system 300 utilizes a question-answering (QA) system 100 to ingest data sources pertaining to user interests as well as other data useful in determining whether a criteria set by a user has been satisfied by current condition sources.

Event monitor function 330 receives event data from various current condition sources 350. In one embodiment, the event data is received at the chatbot system via computer network 102, such as the Internet. These current condition sources can include a wide variety of sources such as various physical sensors 355, GPS/data/time data sources 360, Internet-of-Things (IOT) data sources 370, weather data 375, news and current events data 380, and other data sources that pertain to other interests of the user 390.

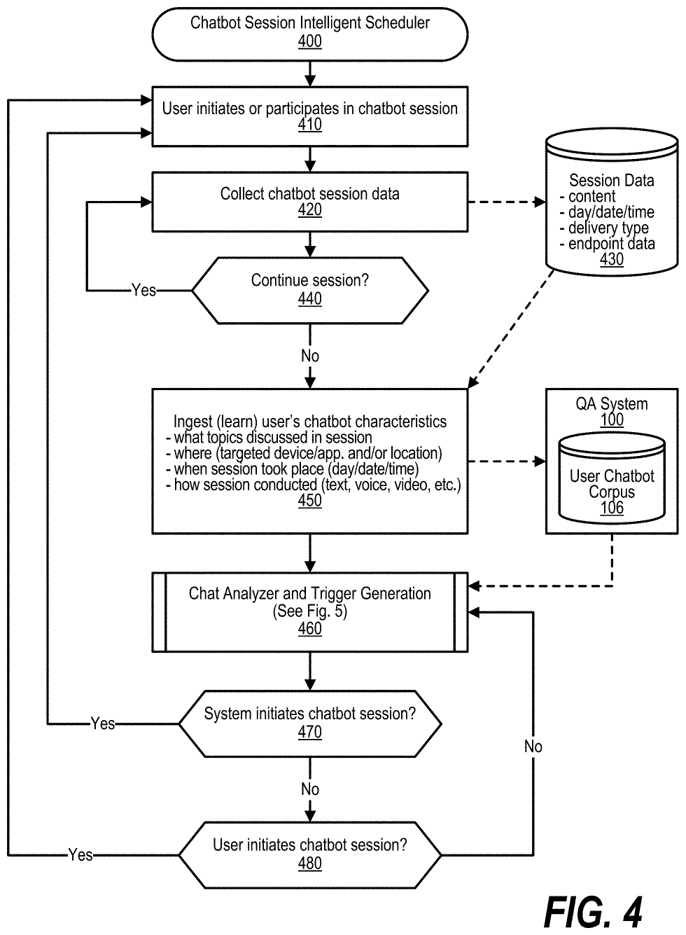

FIG. 4 is a depiction of a flowchart showing the logic used to implement the intelligent scheduler for chatbot sessions system. FIG. 4 processing commences at 400 and shows the steps taken by a process that performs the chatbot session intelligent scheduler routine. At step 410, the user initiates or participates in a chatbot session. The chatbot session can be a verbal session, a textual session, or a video session.

At step 420, the process collects chatbot session data by using natural language processing (NLP) to ingest terms, questions, and phrases input by the user during the session. Other session data attributes are also collected. The attributes for future session are also gathered by analyzing the session data and are stored in data store 430. The attributes of the session data include content data for the current chatbot session as well as user requested content during future automatically generated chatbot sessions. In addition, the date, day, and time data for the current session and any date/day/time triggers for any future chatbot sessions are also retained in data store 430. A delivery type is also stored for the current and future sessions. The delivery type can include the device, such as a automobile-based device, a home-based device, or a mobile device, such as a smart phone. The delivery type can also include any particular chatbot application or application parameters used to provide the chatbot session, as well as a format such as a verbal session, a textual session, or a video session. Endpoint data, such as the current location and any location data pertaining to future requested chatbot session is also retained in data store 430.

The process determines as to whether the user is continuing the chatbot session or has ended the session (decision 440). If the session continues, then decision 440 branches to the ‘yes’ branch which loops back to step 410 to continue the chatbot session with the user and the continued collection of chatbot session data. This looping continues until the chatbot session is terminated, at which point decision 440 branches to the ‘no’ branch exiting the loop.

At step 450, the process ingests, or “learn,” the user's chatbot characteristics. These characteristics can include what topics were discussed in session and requested for future sessions, where the session or future sessions occur (targeted device/application and/or geographic location), when the chatbot session took place (day/date/time) or when a future chatbot session is scheduled to take place, and how the current chatbot session is conducted or how a future chatbot session will be conducted in the future (e.g., text session, voice session, video session, etc.). In one embodiment, this data is ingested into user chatbot corpus 106 that is utilized by QA system 100.

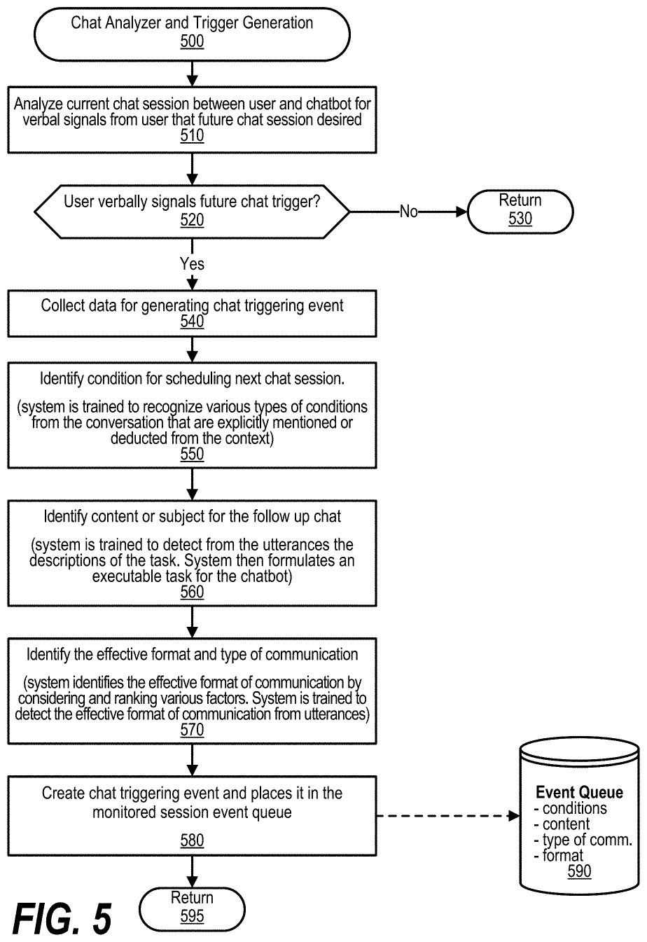

At predefined process 460, the process performs the Chat Analyzer and Trigger Generation routine (see FIG. 5 and corresponding text for processing details). This routine utilizes the ingested chatbot characteristics and further determines whether to initiate a new chatbot session in the future. The process determines as to whether the chatbot system has automatically initiated a new chatbot session (decision 470). If the chatbot system has automatically initiated a new chatbot session, then decision 470 branches to the ‘yes’ branch which loops back to step 410 to initiate the chatbot session with the user and collect chatbot data during the session.

On the other hand, if the chatbot system has not initiated a new chatbot session, then decision 470 branches to the ‘no’ branch. The process determines as to whether the user has initiated (e.g., manually, using a voice command, etc.) a new chatbot session (decision 480). If the user has initiated a new chatbot session, then decision 480 branches to the ‘yes’ branch which loops back to step 410 to initiate the chatbot session with the user and collect chatbot data during the session. On the other hand, if the user has not initiated a new chatbot session, then decision 480 branches to the ‘no’ branch which repeatedly loops back to predefined process 460.

FIG. 5 is a depiction of a flowchart showing the logic used to implement the chat analyzer and trigger generation component. FIG. 5 processing commences at 500 and shows the steps taken by a process that performs the chat analyzer and trigger generation routine. At step 510, the process analyzes the current chat session data between the user and the chatbot system for verbal signals from user that a future chat session is desired by the user. The process determines as to whether the chatbot session data indicates that the user has signaled for a future chatbot session trigger (decision 520). If the chatbot session data indicates that the user has signaled for a future chatbot session trigger, then decision 520 branches to the ‘yes’ branch to perform steps 540 through 595. On the other hand, if the chatbot session data does not indicate that the user has signaled for a future chatbot session trigger, then decision 520 branches to the ‘no’ branch whereupon processing returns to the calling routine at 530.

At step 540, the process collects data for generating chat triggering event. At step 550, the process identifies the condition or conditions for scheduling a next chatbot session with the user. The system is trained to recognize various types of conditions from the conversation that are explicitly mentioned or deducted from the context. At step 560, the process identifies the content or the subject for the follow up chat session. The system is trained to detect the content or subject from the utterances found in the descriptions of the task during the user's chatbot session. The system then formulates an executable task for the chatbot system to act upon to automatically initiate a future chatbot session. At step 570, the process identifies the effective format and the type of communication between the system and the user. The system identifies the effective format of communication by considering and ranking various factors. The system is trained to detect the effective format of communication from utterances input by the user and found in the chatbot session data.

At step 580, the process creates a chat triggering event and places it in the monitored session event queue. The chatbot session event queue data is stored in data store 590 and includes various criteria such as the conditions that are to be met (e.g., location, date/time, etc.) to automatically initiate the future chatbot session, the content requested during the future chatbot session, the type of communications desired, and the format of the communications between the chatbot system and the user. FIG. 5 processing thereafter returns to the calling routine (see FIG. 4) at 595.

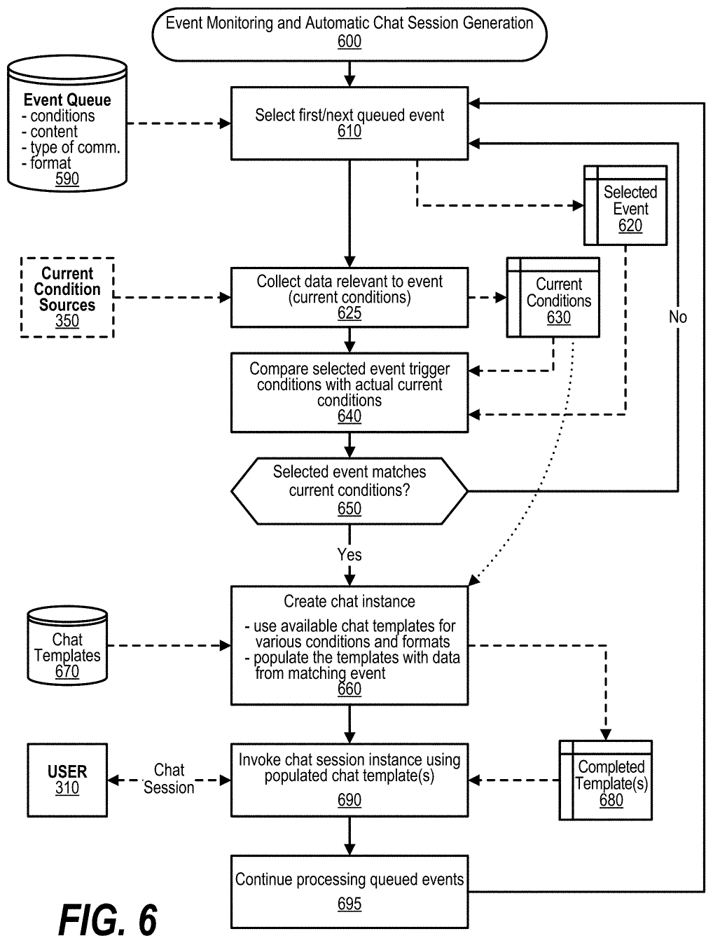

FIG. 6 is a depiction of a flowchart showing the logic performed during the event monitoring and automatic chat session generation. FIG. 6 processing commences at 600 and shows the steps taken by a process that performs the event monitoring and automatic chat session generation routine. At step 610, the process selects the first queued event from chatbot session event queue 590. The selected event data is stored in memory area 620. At step 625, the process collects current condition data from sources 350 that are relevant to the selected event. The relevant current condition data is stored in memory area 630.

At step 640, the process compares the selected event trigger condition data from memory area 620 with the actual current condition data from memory area 630 to determine whether to initiate the selected event. The process determines as to whether the selected event data matches, or is satisfied by, the current condition data (decision 650). If the selected event data matches, or is satisfied by, the current condition data, then decision 650 branches to the ‘yes’ branch to perform steps 660 through 695 that automatically generate a new chatbot session with the user based on the event data. On the other hand, if the selected event data does not match, or is not satisfied by, the current condition data, then decision 650 branches to the ‘no’ branch whereupon processing loops back to step 610 to select and process the next queued event as described above.

At step 660, the process automatically creates a new chat instance. In one embodiment, the system retrieves use available chat templates from data store 670 for various conditions and formats and populates the templates with data from matching event (e.g., content data, etc.). The populated, or completed templates, are stored in memory area 680. At step 690, the process automatically invokes a new chat session instance with user 310 using the populated chat template or templates from memory area 680. After the automatically generated chat session is terminated then, at step 695, the process continues processing queued events to determine whether to automatically create another new chat session based on a different queued event.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method implemented by an information handling system that includes a processor and a memory accessible by the processor, the method comprising:
analyzing a first chat session between a user and a chatbot application;
in response to the analyzing, generating a set of criteria pertaining to a second chat session between the user and the chat application, wherein the set of criteria comprises a cognitive state condition of the user;
monitoring a set of current conditions and comparing the set of current conditions to the set of criteria; and
automatically initiating the second chat session between the user and the chatbot application responsive to the comparison revealing that the set of criteria comprising the cognitive state condition of the user are met by the set of current conditions.

2. The method of claim 1 further comprising:
identifying a user-desired content based on the analysis, wherein the user-desired content is one of the criteria;
identifying a content that satisfies the user-desired content; and
providing the identified content to the user during the initiated second chat session.

3. The method of claim 2 further comprising:
identifying a user-desired future time based on the analysis, wherein the user-desired future time is one of the criteria, wherein the second chat session is initiated at a time based upon the user-desired future time.

4. The method of claim 2 further comprising:
identifying a user-desired geographic location based on the analysis, wherein the user-desired geographic location is one of the criteria; and
repeatedly comparing a plurality of current user geographic locations to the user-desired geographic location, wherein the current user geographic locations are identified based on sets of GPS coordinates received at the information handling system, wherein the second chat session is initiated in response to the current user geographic location matching the user-desired geographic location.

5. The method of claim 2 further comprising:
identifying a device and an application based on the criteria, wherein the second chat session is conducted at the identified device using the identified application.

6. The method of claim 5 further comprising:
identifying a communication type based on the criteria, wherein the communication type is selected from a group consisting of a textual chat session, a voice chat session, and a video chat session.

7. The method of claim 1 further comprising:
determining one or more aspects pertaining to the second chat session, wherein at least one of the aspects is selected from a group consisting of a content, a delivery format, and a communication type.

8. An information handling system comprising:
one or more processors;
a memory coupled to at least one of the processors; and
a set of computer program instructions stored in the memory and executed by at least one of the processors in order to perform actions comprising:
analyzing a first chat session between a user and a chatbot application;
in response to the analyzing, generating a set of criteria pertaining to a second chat session between the user and the chat application, wherein the set of criteria comprises a cognitive state condition of the user;
monitoring a set of current conditions and comparing the set of current conditions to the set of criteria; and
automatically initiating the second chat session between the user and the chatbot application responsive to the comparison revealing that the set of criteria comprising the cognitive state condition of the user are met by the set of current conditions.

9. The information handling system of claim 8 wherein the actions further comprise:
identifying a user-desired content based on the analysis, wherein the user-desired content is one of the criteria;
identifying a content that satisfies the user-desired content; and
providing the identified content to the user during the initiated second chat session.

10. The information handling system of claim 9 wherein the actions further comprise:
identifying a user-desired future time based on the analysis, wherein the user-desired future time is one of the criteria, wherein the second chat session is initiated at a time based upon the user-desired future time.

11. The information handling system of claim 9 wherein the actions further comprise:
identifying a user-desired geographic location based on the analysis, wherein the user-desired geographic location is one of the criteria; and
repeatedly comparing a plurality of current user geographic locations to the user-desired geographic location, wherein the current user geographic locations are identified based on sets of GPS coordinates received at the information handling system, wherein the second chat session is initiated in response to the current user geographic location matching the user-desired geographic location.

12. The information handling system of claim 9 wherein the actions further comprise:
identifying a device and an application based on the criteria, wherein the second chat session is conducted at the identified device using the identified application.

13. The information handling system of claim 12 wherein the actions further comprise:
identifying a communication type based on the criteria, wherein the communication type is selected from a group consisting of a textual chat session, a voice chat session, and a video chat session.

14. The information handling system of claim 8 wherein the actions further comprise:
determining one or more aspects pertaining to the second chat session, wherein at least one of the aspects is selected from a group consisting of a content, a delivery format, and a communication type.

15. A computer program product stored in a computer readable storage medium, comprising computer program code that, when executed by an information handling system, performs actions comprising:
analyzing a first chat session between a user and a chatbot application;
in response to the analyzing, generating a set of criteria pertaining to a second chat session between the user and the chat application, wherein the set of criteria comprises a cognitive state condition of the user;
monitoring a set of current conditions and comparing the set of current conditions to the set of criteria; and
automatically initiating the second chat session between the user and the chatbot application responsive to the comparison revealing that the set of criteria comprising the cognitive state condition of the user are met by the set of current conditions.

16. The computer program product of claim 15 wherein the actions further comprise:
identifying a user-desired content based on the analysis, wherein the user-desired content is one of the criteria;
identifying a content that satisfies the user-desired content; and
providing the identified content to the user during the initiated second chat session.

17. The computer program product of claim 16 wherein the actions further comprise:
identifying a user-desired future time based on the analysis, wherein the user-desired future time is one of the criteria, wherein the second chat session is initiated at a time based upon the user-desired future time.

18. The computer program product of claim 16 wherein the actions further comprise:
identifying a user-desired geographic location based on the analysis, wherein the user-desired geographic location is one of the criteria; and
repeatedly comparing a plurality of current user geographic locations to the user-desired geographic location, wherein the current user geographic locations are identified based on sets of GPS coordinates received at the information handling system, wherein the second chat session is initiated in response to the current user geographic location matching the user-desired geographic location.

19. The computer program product of claim 16 wherein the actions further comprise:
identifying a device and an application based on the criteria, wherein the second chat session is conducted at the identified device using the identified application.

20. The computer program product of claim 19 wherein the actions further comprise:
identifying a communication type based on the criteria, wherein the communication type is selected from a group consisting of a textual chat session, a voice chat session, and a video chat session.
